(19) United States
(12) Patent Application Publication
(10) Pub. No.: US 2023/0009948 A1
(43) Pub. Date: Jan. 12, 2023

(54) POWER SUPPLY COMPONENT AND ELECTRONIC VAPORIZATION DEVICE

(71) Applicant: SHENZHEN SMOORE TECHNOLOGY LIMITED, Shenzhen (CN)

(72) Inventors: Deke XIE, Shenzhen (CN); Weidong ZHOU, Shenzhen (CN); Fengwen LU, Shenzhen (CN); Xiao'an ZHU, Shenzhen (CN)

(21) Appl. No.: 17/845,140

(22) Filed: Jun. 21, 2022

(30) Foreign Application Priority Data
Jul. 8, 2021 (CN) 202110773590.1

(51) Int. Cl. A24F 40/485; A24F 40/50; H01M 50/202; H01M 50/247

(52) U.S. Cl. CPC A24F 40/485; A24F 40/50; H01M 50/202; H01M 50/247; H01M 2220/30

(57) ABSTRACT

A power supply component includes: a housing having an accommodating portion; and a holder arranged on the accommodating portion, a start airway being arranged on the holder, a vent channel being defined between an end of the holder connectable to a vaporization component and the housing, the vent channel being in communication with the start airway and outside air such that the outside air enters the start airway through the vent channel.

### CROSS-REFERENCE TO PRIOR APPLICATION

Priority is claimed to Chinese Patent Application No. CN 202110773590.1, filed on Jul. 8, 2021, the entire disclosure of which is hereby incorporated by reference herein.

### FIELD

This application relates to the technical field of vaporizers, and in particular, to a power supply component and an electronic vaporization device.

### BACKGROUND

An electronic vaporization device is mainly formed by a power supply component and a vaporization component. The vaporization component is configured to vaporize a to-be-vaporized liquid, and the power supply component is configured to supply power to the vaporization component. A microphone is arranged in the power supply component, and the microphone is configured to detect and sense a change of a suction air flow, so as to determine whether to start the electronic vaporization device. However, a to-be-vaporized liquid an existing vaporization component may leak. The to-be-vaporized liquid is likely to enter the microphone through an airway of the microphone, and flows to a control panel, and thus damages the microphone and the control panel.

### SUMMARY

In an embodiment, the present invention provides a power supply component, comprising: a housing having an accommodating portion; and a holder arranged on the accommodating portion, a start airway being arranged on the holder, a vent channel being defined between an end of the holder configured to be connected to a vaporization component and the housing, the vent channel being in communication with the start airway and outside air such that the outside air enters the start airway through the vent channel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic exploded view of a first embodiment of a power supply component according to this application.

FIG. 2 is a schematic structural diagram of the first embodiment of the power supply component according to this application.

FIG. 3 is a partial schematic cross-sectional view of A-A shown in FIG. 2.

FIG. 4 is a first partial schematic diagram of the first embodiment of the power supply component according to this application.

FIG. 5 is a partial schematic cross-sectional view of B-B shown in FIG. 4.

FIG. 6 is a second partial schematic diagram of the first embodiment of the power supply component according to this application.

FIG. 7 is a third partial schematic diagram of the first embodiment of the power supply component according to this application.

FIG. 8 is a fourth partial schematic diagram of connection between a pin and a first elastic piece in the first embodiment of the power supply component according to this application.

FIG. 9 is a schematic structural diagram of the first elastic piece and a patch shown in FIG. 1.

FIG. 10 is a first partial schematic diagram of a second embodiment of the power supply component according to this application.

FIG. 11 is a schematic structural diagram of the first elastic piece shown in FIG. 10 from an angle.

FIG. 12 is a schematic structural diagram of the first elastic piece shown in FIG. 10 from another angle.

FIG. 13 is a schematic structural diagram of a second elastic piece shown in FIG. 1.

FIG. 14 is a fifth partial schematic diagram of connection between a motor and a control panel in the first embodiment of the power supply component according to this application.

### DETAILED DESCRIPTION

In an embodiment, the present invention provides a power supply component and an electronic vaporization device, so as to resolve a problem related to an existing vaporization component that a to-be-vaporized liquid easily enters a microphone through an airway of the microphone and flows to a control panel, and thus damages the microphone and the control panel.

In an embodiment, the present invention provides a power supply component. The power supply component includes: a housing, having an accommodating portion; a holder, arranged on the accommodating portion, where a start airway is arranged on the holder, a vent channel is defined between an end of the holder configured to be connected to a vaporization component and the housing, and the vent channel is in communication with the start airway and outside air, so that the outside air enters the start airway through the vent channel.

A side wall on an end of the start airway close to the vaporization component has an opening, and the start airway is in communication with the vent channel through the opening.

A blocking portion is arranged on an end surface of the holder configured to be connected to the vaporization component to prevent the start airway from being directly exposed to the vaporization component.

A port on an end of the start airway close to the vaporization component is located on the end surface of the holder configured to be connected to the vaporization component, and the blocking portion blocks the port.

At least one air inlet hole is provided on a side wall of the housing, and the vent channel is in communication with the outside air through the at least one air inlet hole.

At least part of an outer side surface on the end of the holder configured to be connected to the vaporization component is recessed to form a vent groove, and the vent channel is formed between the vent groove and the housing.

An end surface of the holder configured to be connected to the vaporization component has a groove, the vent groove is in communication with the groove, and a position where the vent groove is communicated with the groove is higher than a bottom wall of the groove.

The power supply component further includes a control panel, where the control panel and the start airway are located on a same side of the holder, a pin is arranged on the end of the holder configured to be connected to the vaporization component, a first elastic piece is arranged on an end of the control panel configured to be connected to the vaporization component, one end of the first elastic piece is elastically connected to the pin, and an other end of the first elastic piece is connected to the control panel.

The first elastic piece includes a clamping portion, and the clamping portion includes a first clamping arm, a second clamping arm, and a connection portion connected to the first clamping arm and the second clamping arm, and an end portion of the first clamping arm and an end portion of the second clamping arm are bent outward to form a guide structure to guide the pin to be elastically clamped between the first clamping arm and the second clamping arm.

The first elastic piece includes at least one U-shaped plate, an opening of the at least one U-shaped plate is arranged toward the control panel, a side of the U-shaped plate close to the pin elastically abuts against an end portion of the pin, and the U-shaped plate away from the pin is connected to the control panel.

A patch is further arranged on the control panel, and the patch is configured to fix the first elastic piece to the control panel. The first elastic piece is integrally formed with the patch.

The power supply component further includes a battery, where the battery is arranged on the control panel, an electrode tab is arranged on the battery, a second elastic piece is arranged on a side surface of the control panel away from the holder, and the electrode tab is elastically pressed against the second elastic piece to be electrically connected to the control panel.

The second elastic piece includes a conductive sheet, two ends of the conductive sheet are bent toward a same side of the conductive sheet to form two bent portions, and the two bent portions are attached to a side surface of the control panel facing away from the holder.

An accommodating opening is provided on the control panel, and the battery is located in the accommodating opening.

The control panel includes a mainboard control panel and a charging control panel connected to the mainboard control panel, and the accommodating opening is provided between the mainboard control panel and the charging control panel.

A motor is arranged between the control panel and the holder, and the motor is bonded to a side surface of the control panel close to the holder by a bonding member.

In order to resolve the above problem, this application provides an electronic vaporization device. The electronic vaporization device includes a vaporization component and a power supply component, where the power supply component is the above power supply component.

The power supply component of this application includes the housing and the holder, the housing has the accommodating portion, the holder is arranged on the accommodating portion, the start airway is arranged on the holder, the vent channel is defined between the end of the holder configured to be connected to the vaporization component and the housing, and the vent channel is in communication with the start airway and the outside air, so that the outside air enters the start airway through the vent channel. In this way, a condensate or a leaked liquid in the vaporization component is unlikely to enter the start airway and the control panel, so that damage to a microphone and the control panel is avoided, thereby improving a service life of the power supply component.

REFERENCE NUMERALS: 10. Power supply component; 1. Housing; 11. Accommodating portion; 12. Air inlet hole; 2. Holder; 21. Vent groove; 22. Start airway; 23. Port; 24. Groove; 25. Opening; 3. Control panel; 31. Accommodating opening; 32. Mainboard control panel; 33. Charging control panel; 41. Vent channel; 42. Blocking portion; 43. Pin; 44: First elastic piece; 441. First clamping arm; 442. Second clamping arm; 443. Connection portion; 444. Guide structure; 446. U-shaped plate; 447. Arcuate plate; 448. Slidable protrusion; 45: Patch; 454. Sliding groove; 46: Second elastic piece; 461: Conductive sheet; 462. Bent portion; 463: Press-fit portion; 47: Bonding member; 5. Battery; 51. Electrode tab; 6. Motor.

The following clearly and completely describes the technical solutions in the embodiments of the present invention with reference to the accompanying drawings in the embodiments of the present invention. Apparently, the described embodiments are merely some of the embodiments rather than all of the embodiments of the present invention. All other embodiments obtained by a person of ordinary skill in the art based on the embodiments of the present invention without creative efforts shall fall within the protection scope of the present invention.

It should be noted that all directional indications (for example, upper . . . ) involved in the embodiments of the present disclosure are only used for explaining relative position relationships, movement situations or the like between the various components in a specific posture (as shown in the accompanying drawings). If the specific posture changes, the directional indications change accordingly.

In addition, if terms such as “first” and “second” are involved in the embodiments of the present invention, the terms such as “first” and “second” are merely used for descriptive purposes and shall not be understood as indicating or implying relative importance or implying a quantity of indicated technical features. Therefore, features defining “first” and “second” can explicitly or implicitly include at least one of the features. In addition, technical solutions of various embodiments may be combined with each other but need to be based on the technical solutions that can be implemented by a person of ordinary skill in the art. When a combination of the technical solutions is contradictory or cannot be implemented, it should be considered that such a combination of the technical solutions does not exist and does not fall within the protection scope of the present invention.

A power supply component and an electronic vaporization device provided in the present invention are described in detail below with reference to the embodiments.

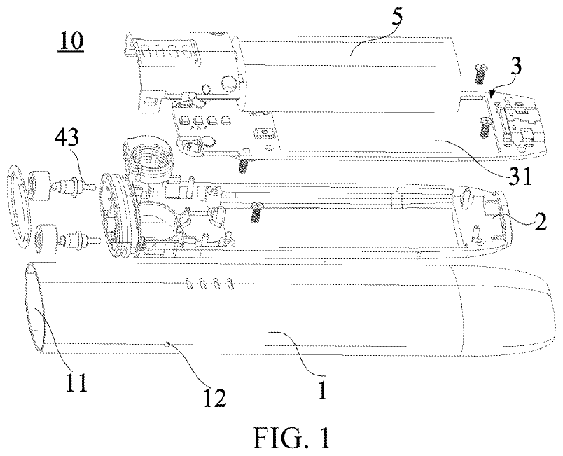

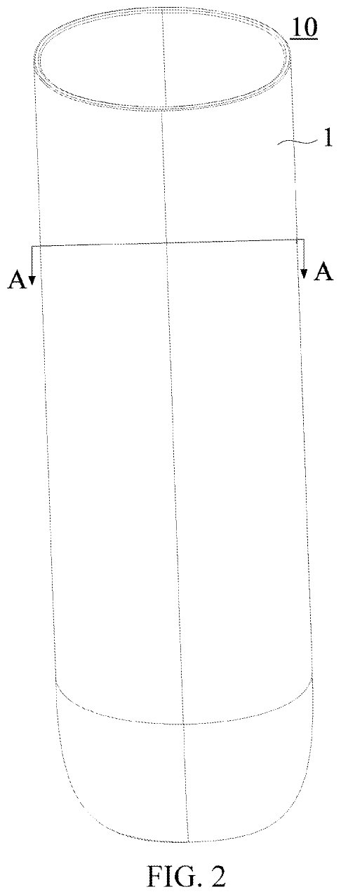

Referring to FIG. 1 and FIG. 2, FIG. 1 is a schematic exploded view of a first embodiment of a power supply component according to this application, and FIG. 2 is a schematic structural diagram of the first embodiment of the power supply component according to this application.

The electronic vaporization device is applicable to vaporization of a to-be-vaporized liquid. The electronic vaporization device includes a vaporization component and a power supply component 10 connected to each other. The vaporization component is configured to store a to-be-vaporized liquid and vaporize the liquid to form an aerosol inhalable by a user. The liquid may be a to-be-vaporized liquid such as a liquid or a medicine liquid containing fragrance or smell. The power supply component 10 is configured to supply power to the vaporization component, so that the vaporization component can vaporize the to-be-vaporized liquid to form an aerosol. The vaporization component may be integrally formed with or detachably connected to the power supply component 10, which is designed according to specific requirements.

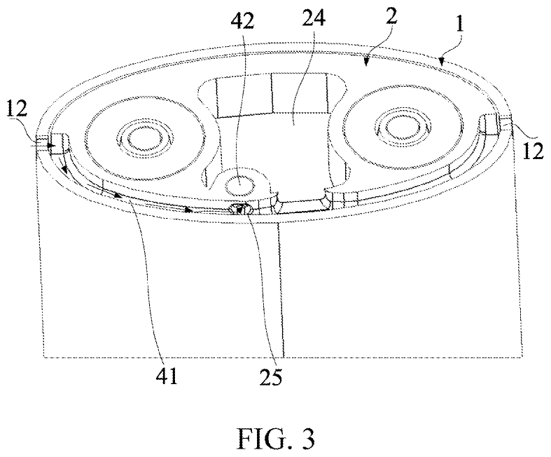

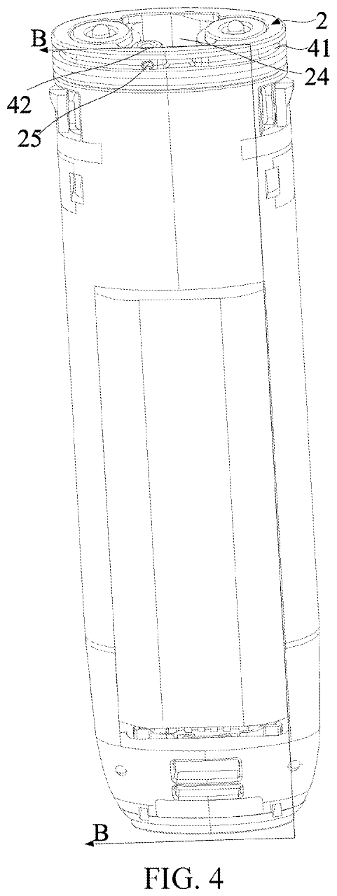

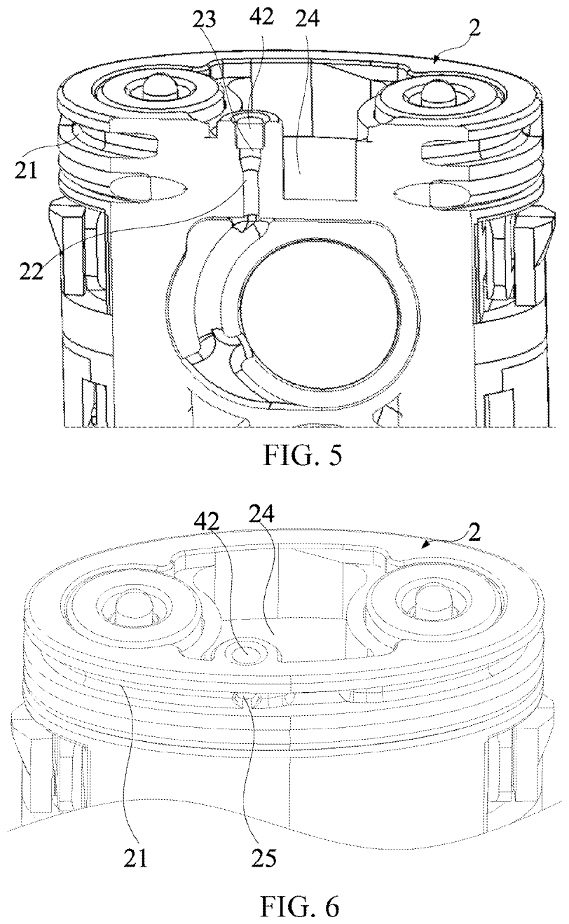

Referring to FIG. 3, FIG. 4, and FIG. 5, FIG. 3 is a partial schematic cross-sectional view of A-A shown in FIG. 2, FIG. 4 is a first partial schematic diagram of the first embodiment of the power supply component according to this application, and FIG. 5 is a partial schematic cross-sectional view of B-B shown in FIG. 4.

Specifically, with reference to FIG. 1, the power supply component 10 includes a housing 1 and a holder 2. The housing 1 has an accommodating portion 11 formed thereon, and the accommodating portion 11 accommodates at least part of the vaporization component. The holder 2 is arranged in the accommodating portion 11, and is configured to be connected to the vaporization component. A start airway 22 is arranged on the holder 2. A vent channel 41 is defined between an end of the holder 2 configured to be connected to the vaporization component and the housing 1. The vent channel 41 is in communication with outside air and the start airway 22, so that the outside air enters the start airway 22 through the vent channel 41. A flowing direction of the outside air is a direction indicated by an arrow in FIG. 3. In this way, a condensate or a leaked liquid in the vaporization component is unlikely to enter the start airway 22 and a control panel 3, so that damage to a microphone and the control panel 3 is avoided, thereby improving a service life of the power supply component 10.

In an embodiment, in order to realize the connection between the start airway 22 and the vent channel 41, an opening 25 is required to be provided on a side wall on an end of the start airway 22 close to the vaporization component. In this case, the start airway 22 is in communication with the vent channel 41 through the opening 25. Therefore, the outside air enters the start airway 22 through an air inlet hole 12, the vent channel 41, and the opening 25 in sequence.

In order to further prevent the condensate or the leaked liquid in the vaporization component from directly entering the start airway 22, a blocking portion 42 is arranged on an end surface of the holder 2 configured to be connected to the vaporization component. The blocking portion 42 is configured to prevent the start airway 22 from being directly exposed to the vaporization component, so as to prevent the to-be-vaporized liquid from directly entering the start airway 22 along a vertical direction, that is, a length direction of the power supply component 10 and damaging the microphone and the control panel 3.

Further, with reference to FIG. 3 and FIG. 5, a port 23 on an end of the start airway 22 close to the vaporization component is located on the end surface of the holder 2 configured to be connected to the vaporization component, and the blocking portion 42 blocks the port 23 to achieve sealed blocking. The blocking portion 42 may be a plastic blocking portion. For example, the plastic blocking portion may be made of plastic.

In an embodiment, with reference to FIG. 1 to FIG. 5, an air inlet hole 12 is provided on a side wall of the housing 1. One or more air inlet holes 12 may be provided. The outside air may be introduced into the vent channel 41 through the one or more air inlet holes 12, so that the outside air enters the start airway 22 through the plurality of air inlet holes 12 and the vent channel 41 in sequence. In this embodiment, two air inlet holes 12 are provided. The air inlet holes 12 are symmetrically arranged on two side walls of the housing 1 along a width direction of the power supply component 10 and correspond to opposite ends of the vent channel 41 respectively. It may be understood that three, four, or five air inlet holes 12 may be provided, as long as the air inlet holes 12 are formed on the side wall of the housing 1. The air inlet holes 12 may be symmetrically arranged on the housing 1, or may not be symmetrically arranged. This is not limited herein. In addition, the air inlet hole 12 may be in any shape, such as a circle or a square. This is not limited herein.

Referring to FIG. 6, FIG. 6 is a second partial schematic diagram of the first embodiment of the power supply component according to this application. With reference to FIG. 1 to FIG. 5, the vent channel 41 is formed between the end of the above holder 2 configured to be connected to the vaporization component and the housing 1. The vent channel 41 may be formed in at least the following two manners: Specifically, a first manner of forming the vent channel 41 is as follows: At least part of an outer side surface on the end of the holder 2 configured to be connected to the vaporization component is recessed to form a vent groove 21, and the vent channel 41 is formed between the vent groove 21 and an inner surface of the housing 1. The vent groove 21 extends along a circumference of the outer side surface on the end of the holder 2 configured to be connected to the vaporization component. For example, in this embodiment, the two air inlet holes 12 are located on symmetrical sides of the side wall of the housing 1, and the vent groove 21 is recessed on the outer side surface on the end of the holder 2 configured to be connected to the vaporization component. The two air inlet holes 12 are respectively located on two symmetrical ends of the vent groove 21, and are both arranged in communication with the vent groove 21.

A second manner of forming the vent channel 41 is as follows: At least part of the inner surface of the housing 1 is recessed to form a vent groove 21, and the vent channel 41 is formed between the vent groove 21 and the outer side surface on the end of the holder 2 configured to be connected to the vaporization component. A third manner of forming the vent channel 41 is as follows: At least part of the outer side surface on the end of the holder 2 configured to be connected to the vaporization component is recessed to form a first vent groove, and at least part of the inner surface of the housing 1 is recessed to form a second vent groove. The first vent groove and the second vent groove define the vent channel 41. Certainly, the vent channel 41 may be formed in other manners. This is not limited herein.

In an embodiment, with reference to FIG. 1 to FIG. 6, a groove 24 is provided on an end surface of the holder 2 configured to be connected to the vaporization component. The groove 24 is configured to store a condensate or a leaked liquid flowing into the power supply component 10 from the vaporization component. Since the vent groove 21 is in communication with the start airway 22, in order to prevent a leaked liquid in the groove 24 from entering the start airway 22 through the vent groove 21, a position where the vent groove 21 is communicated with the groove 24 is arranged to be higher than a bottom wall of the groove 24, so as to prevent the condensate or the leaked liquid in the groove 24 from entering the start airway 22 through the vent groove 21.

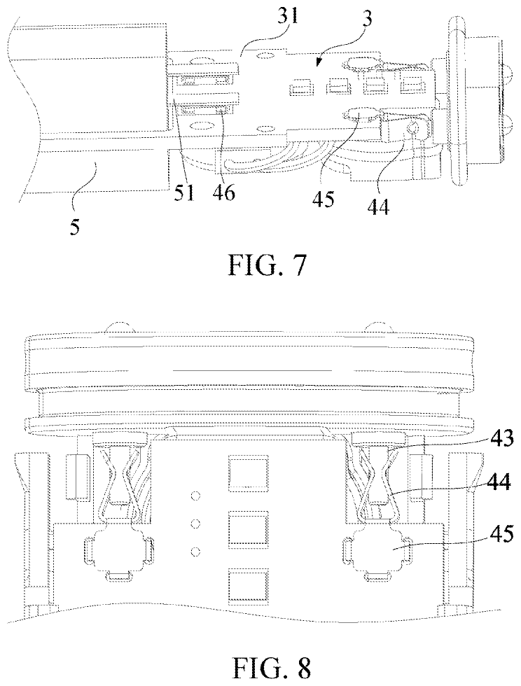

Referring to FIG. 7 and FIG. 8, FIG. 7 is a third partial schematic diagram of the first embodiment of the power supply component according to this application, and FIG. 8 is a fourth partial schematic diagram of connection between a pin and a first elastic piece in the first embodiment of the power supply component according to this application. In an embodiment, the power supply component 10 further includes a control panel 3. The control panel 3 and the start airway 22 are located on a same side of the holder 2, so that the microphone is located between the control panel 3 and the holder 2. In addition, the control panel 3 and the holder 2 are stacked, so that a structure of the power supply component 10 is more compact and smaller. At least two pins 43 are arranged on the end of the holder 2 configured to be connected to the vaporization component, and at least two first elastic pieces 44 are arranged on an end of the control panel 3 configured to be connected to the vaporization component. The pins 43 are connected to the first elastic pieces 44 in a one-to-one correspondence. One end of each of the first elastic pieces 44 is elastically connected to an end portion of each of the pins 43, and an other end of the first elastic piece 44 is connected to the control panel 3. Electrical connection between the pin 43 and the control panel 3 can be realized by the first elastic piece 44. The first elastic piece 44 may have varying structures, as long as the first elastic piece can realize the electrical connection between the pin 43 and the control panel 3.

In a specific embodiment, in order to enhance the contact between the pin 43 and the first elastic piece 44 so as to enhance the electrical connection between the pin 43 and the control panel 3, one end of the pin 43 is elastically clamped into the first elastic piece 44, that is, the one end of the pin 43 is snugly clamped in the first elastic piece 44 by an elastic force of the first elastic piece 44, so that the pin 43 can be in desirable contact with the first elastic piece 44. An other end of the pin 43 is configured to be connected to the vaporization component, so as to realize the connection between the vaporization component and the power supply component 10.

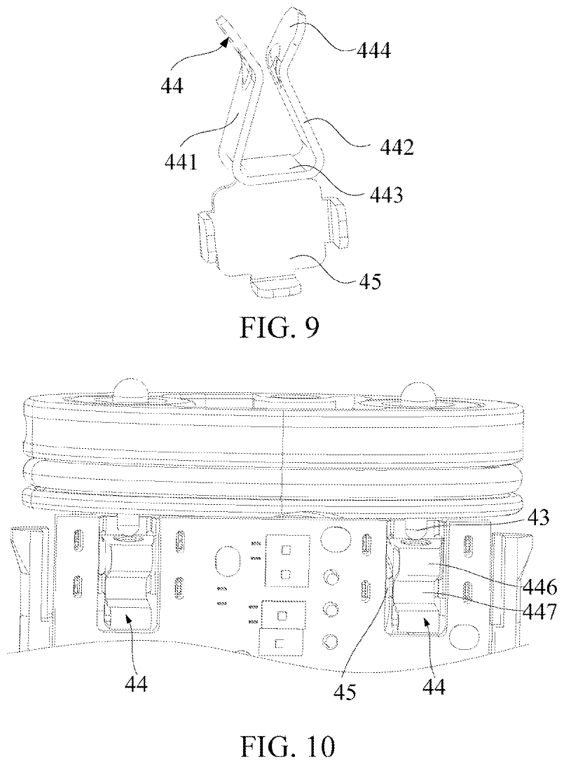

Referring to FIG. 9, FIG. 9 is a schematic structural diagram of the first elastic piece and a patch shown in FIG. 1. With reference to FIG. 7 and FIG. 8, specifically, the first elastic piece 44 includes a clamping portion. The one end of the pin 43 is clamped by the clamping portion. The clamping portion includes a first clamping arm 441, a second clamping arm 442, and a connection portion 443. The first clamping arm 441 and the second clamping arm 442 are respectively located on two ends of the connection portion 443 and are arranged opposite to each other. The first clamping arm 441 and the second clamping arm 442 are configured to clamp the one end of the pin 43 to snugly clamp the pin 43.

The first clamping arm 441 and the second clamping arm 442 may be arranged in parallel, or may gradually approach each other in a direction leaving the connection portion 443. As shown in FIG. 9, in order to further guide the pin 43 to be clamped between the first clamping arm 441 and the second clamping arm 442, an end portion of the first clamping arm 441 and an end portion of the second clamping arm 442 are bent outward to form a guide structure 444. That is to say, the end portion of the first clamping arm 441 and the end portion of the second clamping arm 442 gradually move away from each other along the direction leaving the connection portion 443 to form a V-shaped guide structure 444. The guide structure 444 is configured to guide the pin 43 to be clamped between the first clamping arm 441 and the second clamping arm 442, thereby guiding assembly for the pin 43.

Further, as shown in FIG. 9, the first clamping arm 441 and the second clamping arm 442 may first gradually approach each other and then gradually move away from each other along the direction leaving the connection portion 443. A position where the first clamping arm 441 and the second clamping arm 442 are closest to each other is used for clamping the one end of the pin 43, and a position where the first clamping arm 441 and the second clamping arm 442 gradually move away from each other is used for guiding the pin 43 into the clamping portion. Certainly, in other embodiments, the first clamping arm 441 and the second clamping arm 442 are first arranged in parallel and then arranged gradually away from each other along the direction leaving the connection portion 443. In addition, in order to improve strength of the first elastic piece 44, reinforcing ribs may be arranged on the first clamping arm 441 and the second clamping arm 442 to enhance the strength.

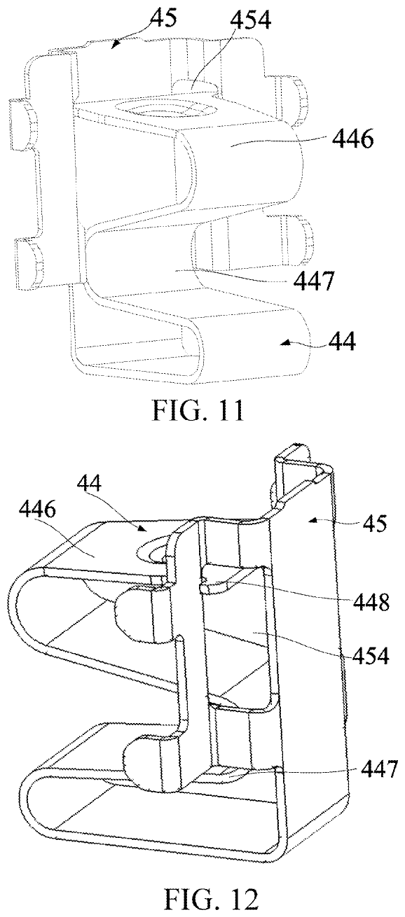

Referring to FIG. 10 and FIG. 11, FIG. 10 is a first partial schematic diagram of a second embodiment of the power supply component according to this application, and FIG. 11 is a schematic structural diagram of the first elastic piece shown in FIG. 10 from an angle. In another specific embodiment, the first elastic piece 44 may be configured as other structures. For example, one end of the pin 43 abuts against an end portion of the first elastic piece 44. Since the first elastic piece 44 has elasticity, the end portion of the first elastic piece 44 can abut against the pin 43 more desirably when the first elastic piece 44 is deformed by a force, thereby enhancing the contact between the pin 43 and the first elastic piece 44.

Specifically, the first elastic piece 44 includes at least one U-shaped plate 446 arranged in sequence, and an opening of each of the at least one U-shaped plate 446 is arranged toward the control panel 3. The one end of the pin 43 elastically abuts against a side of a U-shaped plate 446 closest to the pin 43, and a U-shaped plate 446 away from the pin 43 is configured to be connected to the control panel 3. That is to say, electrical connection between the pin 43 and the control panel 3 can be realized by the at least one U-shaped plate 446. When the side of the U-shaped plate 446 close to the pin 43 is stressed, the side can recover elasticity thereof, so as to abut against the one end of the pin 43.

One or more U-shaped plates 446 may be arranged. When a plurality of U-shaped plates 446 are arranged, the first elastic piece 44 further includes at least one arcuate plate 447. One or more arcuate plates 447 may be arranged. Each arcuate plate 447 is arranged between adjacent U-shaped plates 446. The U-shaped plate 446 and the arcuate plate 447 may be fixedly connected or integrally formed. Therefore, the first elastic pieces 44 may be arranged in a U shape, a W shape, a shape of a combination of a plurality of U shapes and W shapes, a shape of a combination of a plurality of W shapes, or the like. The specific shape of the first elastic pieces 44 is not limited herein. For example, in this embodiment, the first elastic pieces 44 are arranged in a W shape.

By configuring the first elastic pieces 44 in the above shape, a deformation and a service life thereof can be ensured, and the pin 43 can be in desirable contact with one side of the U-shaped plate 446 in the first elastic piece 44. In addition, compared with the above embodiment in which the one end of the pin 44 is directly clamped into the first elastic piece 44, in this embodiment, the first elastic piece 44 and the pin 44 are in separable contact with each other, and the pin 44 and the first elastic piece 44 can be easily mated with each other.

In an embodiment, referring to FIG. 7, FIG. 8, and FIG. 9, a patch 45 is further arranged on the control panel 3. The patch 45 is configured to fix the first elastic piece 44 to the control panel 3, to realize stable connection between the first elastic piece 44 and the control panel 3. In addition, in order to reduce a volume occupied by the first elastic piece 44, a gap may be formed on an end surface of the control panel 3 close to the vaporization component. The first elastic piece 44 may be arranged in the gap, and the first elastic piece 44 is connected to the patch 45 to connect the first elastic piece 44 to the control panel 3. In this way, the connection between the first elastic piece 44 and the control panel 3 is more compact, and a volume occupied in the power supply component 10 is reduced. In other embodiments, gaps are respectively formed on opposite sides of the end surface of the control panel 3 close to the vaporization component, and two first elastic pieces 44 are respectively arranged in the two gaps.

Due to the different structure of the first elastic piece 44, the first elastic piece 44 is connected to the patch 45 in a different manner. For example, in a specific embodiment, the first elastic piece 44 is fixedly connected to or integrally formed with the patch 45, so that the pin 43 can be electrically connected to the control panel 3 more desirably. For example, the patch 45 is integrally formed with and connected to the connection portion 443 of the first elastic piece 44.

Referring to FIG. 12, FIG. 12 is a schematic structural diagram of the first elastic piece shown in FIG. 10 from another angle. With reference to FIG. 10 and FIG. 11, in another specific embodiment, the opening of the first elastic piece 44 faces the patch 45, the first elastic piece 44 and the patch 45 are arranged opposite to each other, and an end of the first elastic piece 44 away from the pin is fixedly connected to or integrally formed with the patch 45. That is to say, the first elastic piece 44 is mounted to the control panel 3 by the patch 45. An end of the first elastic piece 44 close to the pin 44 may be compressed into deformation along a side of the patch 45, to control a compression and deformation direction of the first elastic piece 44, thereby preventing deviation of the first elastic piece and impact on the abutment of the one end of the pin 43.

Further, sliding grooves 454 are provided on two sides of the patch 45, and slidable protrusions 448 protrude from an end on one side of the U-shaped plate 446. The slidable protrusions 448 are engaged with sides of the sliding grooves 454. After the side of the U-shaped plate 446 is stressed, the slidable protrusions 448 can slide and move along the sides of the sliding grooves 454, thereby defining a direction of the deformation of the first elastic piece 44.

In order to reduce a volume occupied by the patch 45 in the power supply component 10, the patch 45 may be configured with at least two claws. The patch 45 is engaged with the control panel 3 by the claws. In this way, stable connection between the patch 45 and the control panel 3 can be realized, and the occupied volume can be reduced, so that the structure is compact. As shown in FIG. 8 and FIG. 9, in this embodiment, the patch 45 is arranged in a square shape and includes three claws. The three claws are respectively arranged on three adjacent sides of the patch 45, and the connection portion 443 of the first elastic piece 44 is arranged on a side of the patch 45 having no claw arranged thereon. As shown in FIG. 10 and FIG. 11, in this embodiment, the patch 45 is arranged in a rectangular shape. The patch 45 has two sides symmetrically arranged and each having two claws arranged thereon. The four claws are engaged with the control panel 3.

In an embodiment, referring to FIG. 7, the power supply component 10 further includes a battery 5. The battery 5 is configured to supply power to the vaporization component. The battery 5 is arranged on the control panel 3. An electrode tab 51, such as a positive electrode tab and a negative electrode tab is arranged on an end of the battery 5 close to the vaporization component. In order to enhance contact between the battery 5 and the control panel 3, a second elastic piece 46 is arranged on a side surface of the control panel 3 away from the holder 2. Since the second elastic piece 46 has elasticity, when the electrode tab 51 is elastically pressed against the second elastic piece 46, the second elastic piece 46 is deformed, thereby ensuring tight contact between the electrode tab 51 and the second elastic piece 46. In this way, desirable electrical connection between the battery 5 and the control panel 3 is realized.

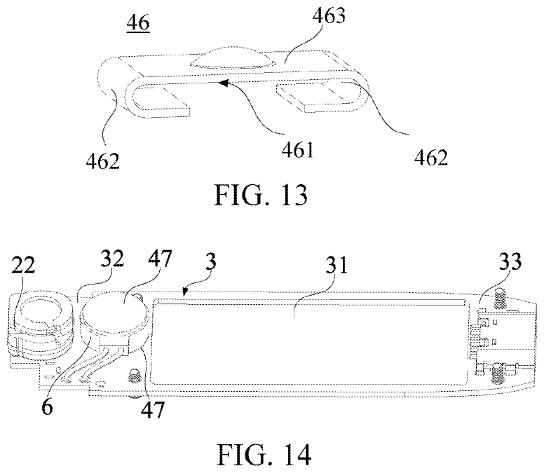

Referring to FIG. 13, FIG. 13 is a schematic structural diagram of the second elastic piece shown in FIG. 1. With reference to FIG. 7, specifically, the second elastic piece 46 includes a conductive sheet 461. The conductive sheet 461 has wire properties. For example, the conductive sheet 461 may include but is not limited to a metal sheet or a graphite sheet. Two ends of the conductive sheet 461 are bent toward a same side of the conductive sheet 461 to form two bent portions 462. The two bent portions 462 are arranged opposite to each other. The two bent portions 462 are attached to the side surface of the control panel 3 facing away from the holder 2. When the electrode tab 51 is pressed against the middle of the conductive sheet 461, the conductive sheet 461 is deformed, and the two bent portions 462 provides support, so as to further ensure the tight contact between the electrode tab 51 and the second elastic piece 46.

An end portion between the two bent portions 462 configured to be connected to the electrode tab 51 may be the press-fit portion 463, sides of the bent portions 462 close to the control panel 3 are parallel to the surface of the control panel 3, and sides of the bent portions 462 away from the control panel 3 are parallel to the press-fit portion 463. Each of the bent portions 462 may be arranged in an arcuate shape, a circular shape, or the like. Optionally, a longitudinal section of the bent portion 462 is arranged in a “C” shape. In an embodiment, the two bent portions 462 are arranged coplanarly and are parallel to the control panel 3 and the press-fit portion 463 respectively.

Referring to FIG. 14, FIG. 14 is a fifth partial schematic diagram of connection between a motor and the control panel in the first embodiment of the power supply component according to this application. With reference to FIG. 1, in an embodiment, an accommodating opening 31 is provided on the control panel 3 for accommodating the battery 5, so that the structure of the power supply component 10 is more compact, and an overall appearance size of the power supply component 10 is reduced. In addition, the electrode tab 51 on the battery 5 may be arranged on an end of the control panel 3 close to the vaporization component.

Specifically, the control panel 3 includes a mainboard control panel 32 and a charging control panel 33 connected to the mainboard control panel 32, that is, the mainboard control panel 32 and the charging control panel 33 are combined into an integrated control panel 3. In this way, a welding wire between the mainboard control panel and the charging control panel is reduced, and steps of connecting and mounting related electronics between the mainboard control panel 32 and the charging control panel 33 are reduced. Only the battery 5 is required to be mounted subsequently. In addition, the accommodating opening 31 is formed between the mainboard control panel 32 and the charging control panel 33, and the accommodating opening 31 is configured to accommodate the battery 5. In an embodiment, the mainboard control panel 32 and the charging control panel 33 are directly manufactured on a same PCB board, and the accommodating opening 31 is provided in the middle of the PCB board.

In an embodiment, with reference to FIG. 1 and FIG. 14, a motor 6 is arranged between the control panel 3 and the holder 2. The motor 6 is bonded to a side surface of the control panel 3 close to the holder 2 by a bonding member 47, so as to realize stable connection between the motor 6 and the control panel 3. The above bonding member 47 may be foam glue or the like, which is not limited herein. Moreover, the motor 6 may be bonded to a side surface of the holder 2 close to the control panel 3 by the bonding member 47, so as to realize stable connection between the motor 6 and the control panel 3.

Compared with the prior art, in this embodiment, the power supply component includes the housing and the holder, the housing has the accommodating portion, the holder is arranged on the accommodating portion, the start airway is arranged on the holder, the vent channel is defined between the end of the holder configured to be connected to the vaporization component and the housing, and the vent channel is in communication with the start airway and the outside air, so that the outside air enters the start airway through the vent channel. In this way, the to-be-vaporized liquid in the vaporization component is unlikely to enter the start airway and the control panel, so that damage to a microphone and the control panel is avoided, thereby improving a service life of the power supply component.

In an embodiment, with reference to FIG. 1, an electronic vaporization device includes a vaporization component and a power supply component 10. The vaporization component is configured to vaporize a condensate or a leaked liquid, and the power supply component 10 is configured to supply power to the vaporization component. The power supply component 10 is the power supply component 10 described above, and therefore are not described in detail herein again. A structure of the vaporization component is not limited.

In an embodiment, the vaporization component includes a vaporization tube, a vaporization core, and a heating base. The vaporization tube has a liquid storage cavity, a vaporization channel, and an accommodating cavity. The heating base is arranged in the accommodating cavity and forms a mounting cavity, and the vaporization core is arranged in the mounting cavity.

The foregoing descriptions are merely implementations of this application, and the protection scope of this application is not limited thereto. All equivalent structure or process changes made according to the content of this specification and accompanying drawings in this application or by directly or indirectly applying this application in other related technical fields shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A power supply component, comprising:
a housing having an accommodating portion; and
a holder arranged on the accommodating portion, a start airway being arranged on the holder, a vent channel being defined between an end of the holder configured to be connected to a vaporization component and the housing, the vent channel being in communication with the start airway and outside air such that the outside air enters the start airway through the vent channel.

2. The power supply component of claim 1, wherein a side wall on an end of the start airway close to the vaporization component has an opening, and
wherein the start airway is in communication with the vent channel through the opening.

3. The power supply component of claim 1, wherein a blocking portion is arranged on an end surface of the holder configured to be connected to the vaporization component so as to prevent the start airway from being directly exposed to the vaporization component.

4. The power supply component of claim 3, wherein a port on an end of the start airway close to the vaporization component is located on the end surface of the holder configured to be connected to the vaporization component, and
wherein the blocking portion blocks the port.

5. The power supply component of claim 4, wherein at least one air inlet hole is provided on a side wall of the housing, and
wherein the vent channel is in communication with the outside air through the at least one air inlet hole.

6. The power supply component of claim 4, wherein at least part of an outer side surface on the end of the holder configured to be connected to the vaporization component is recessed to form a vent groove, and
wherein the vent channel is formed between the vent groove and the housing.

7. The power supply component of claim 6, wherein an end surface of the holder configured to be connected to the vaporization component has a groove, the vent groove being in communication with the groove, and
wherein a position where the vent groove is communicated with the groove is higher than a bottom wall of the groove.

8. The power supply component of claim 1, further comprising:
a control panel,
wherein the control panel and the start airway are located on a same side of the holder,
wherein a pin is arranged on the end of the holder configured to be connected to the vaporization component, and
wherein a first elastic piece is arranged on an end of the control panel configured to be connected to the vaporization component, one end of the first elastic piece being elastically connected to the pin, and an other end of the first elastic piece being connected to the control panel.

9. The power supply component of claim 8, wherein the first elastic piece comprises a clamping portion,
wherein the clamping portion comprises a first clamping arm, a second clamping arm, and a connection portion connected to the first clamping arm and the second clamping arm, and
wherein an end portion of the first clamping arm and an end portion of the second clamping arm are bent outward to form a guide structure so as to guide the pin to be elastically clamped between the first clamping arm and the second clamping arm.

10. The power supply component of claim 8, wherein the first elastic piece comprises at least one U-shaped plate,
wherein an opening of the at least one U-shaped plate is arranged toward the control panel,
wherein a side of the U-shaped plate close to the pin elastically abuts an end portion of the pin, and
wherein the U-shaped plate away from the pin is connected to the control panel.

11. The power supply component of claim 8, wherein a patch is further arranged on the control panel, and
wherein the patch is configured to fix the first elastic piece to the control panel.

12. The power supply component of claim 11, wherein the first elastic piece is integrally formed with the patch.

13. The power supply component of claim 8, further comprising:
a battery arranged on the control panel;
an electrode tab is arranged on the battery; and
a second elastic piece arranged on a side surface of the control panel away from the holder,
wherein the electrode tab is elastically pressed against the second elastic piece to be electrically connected to the control panel.

14. The power supply component of claim 13, wherein the second elastic piece comprises a conductive sheet,
wherein two ends of the conductive sheet are bent toward a same side of the conductive sheet to form two bent portions, and
wherein the two bent portions are attached to a side surface of the control panel facing away from the holder.

15. The power supply component of claim 13, wherein an accommodating opening is provided on the control panel, and
wherein the battery is located in the accommodating opening.

16. The power supply component of claim 15, wherein the control panel comprises a mainboard control panel and a charging control panel connected to the mainboard control panel, and
wherein the accommodating opening is provided between the mainboard control panel and the charging control panel.

17. The power supply component of claim 13, wherein a motor is arranged between the control panel and the holder, and
wherein the motor is bonded to a side surface of the control panel close to the holder by a bonding member.

18. An electronic vaporization device, comprising:
a vaporization component; and
the power supply component of claim 1.
